(19) United States
(12) Patent Application Publication
(10) Pub. No.: US 2024/0334909 A1
(43) Pub. Date: Oct. 10, 2024

(54) CAT CHEW TOY

(71) Applicant: Samantha Anne MCCONNELL, Richmond (CA)

(72) Inventor: Samantha Anne MCCONNELL, Richmond (CA)

(21) Appl. No.: 18/627,850

(22) Filed: Apr. 5, 2024

Related U.S. Application Data
(63) Continuation-in-part of application No. 18/132,381, filed on Apr. 8, 2023.

(51) Int. Cl. A01K 15/02

(52) U.S. Cl. CPC A01K 15/026

(57) ABSTRACT

A cat chew toy is disclosed. The cat chew toy is made from materials comprising natural materials. In some embodiments, the natural materials are derived from plants. The cat chew toy may comprise an elongated stick extending longitudinally from a first end to an opposing second end, a first plurality of fibers extending outwardly from the first end of the stick, a second plurality of fibers extending outwardly from the second end of the stick, a dried fruit extending outwardly from one or both of the first and second ends of the stick, and a first rope winding around the elongated stick.

### CROSS-REFERENCE TO RELATED APPLICATIONS

This application is a continuation-in-part of U.S. application Ser. No. 18/132,381 filed 8 Apr. 2023 entitled CAT CHEW TOY which is hereby incorporated herein by reference for all purposes. For purposes of the United States of America, this application claims the benefit under 35 U.S.C. § 119 of U.S. application Ser. No. 18/132,381 filed 8 Apr. 2023 entitled CAT CHEW TOY which is hereby incorporated herein by reference for all purposes.

### FIELD OF THE INVENTION

The invention pertains to toys for cats, in particular, those that are chewable.

### BACKGROUND

Cat toys are known in the art. Examples of cat toys that are commercially available include strings that are attached to wands, fake animals such as mice and birds, ball and track systems, etc.

For instance, U.S. Pat. No. 8,944,011 discloses an impact action cat toy where the cat owner creates erratic movements of a cat toy play member which is situated at the end of a cord. The cat toy play member can be constructed using a cork and feathers, and the cat owner creates the movement of the toy by moving the rigid tube in a wand like fashion.

U.S. Pat. No. 6,032,615 discloses a ball contained in a track system which appears to simulate a mouse going into a hole. A cat playing with this device can touch the ball, but the ball will always move away from the cat within the confined track. Similarly, U.S. Pat. No. 5,579,725 discloses a toy animal simulating a mouse contained within a circular housing. The '725 Patent also provides a motorized device where the toy animal is mounted on the outer end of a motor-driven arm. A cat playing with this toy will catch the toy animal momentarily, but the toy animal will begin moving again in a circular pattern through the motor driven arm once released.

U.S. Pat. No. 3,830,202 discloses a two-ended pet toy that includes a flexible rope that is partially jacketed by a solid, bowling-pin shaped, outer structure. Often a pet may bite down on one end of the rope in its mouth and shake its head holding the end of the rope in its mouth. As a result, the solid, outer structure may fly around and slap the pet in the head causing pain and discomfort and perhaps injury to the pet.

U.S. Pat. No. 4,133,296 discloses a two-ended pet toy that has weights located at opposite ends of a flexible tubular member. U.S. Pat. No. 5,033,410 discloses a two-ended pet toy that is rope-like and has bristle structure. The toy may be impregnated with flavor material. U.S. Pat. No. 5,174,243 discloses a two-ended pet toy that has bone-like covers at either end, and a rope-like structure connecting the two ends. The amount and type of play activity that can be employed by either the person with the pet or the pet by itself is relatively limited.

U.S. Pat. No. 5,092,272 discloses a pet toy based on rope that has two free ends and a closed loop for a third end. The closed loop has its own handle which jackets a rope portion. A disadvantage of the jacket for the rope portion is that the jacket may fall apart during rough play and cause a hazard to the eyes and the throat of the pet. Another disadvantage of this toy is the closed loop. A pet may get its head caught in the closed loop and may possibly choke from it.

As mentioned above, U.S. Pat. No. 5,033,410 discloses a rope-like toy that is impregnated with flavor material. The presence of flavor material may provide benefits in inducing the pet to chew, which may be a healthy activity. However, a limited amount of flavor material may be carried by the rope-like material. Once the limited amount of flavor material is used up, the toy no longer bears the flavor. It would be desirable for a pet toy which permitted periodic addition of flavor material without depending upon only an initial amount of impregnated flavoring material.

There is a need for an improved cat chew toy that is made with natural and eco-friendly materials which is durable and long-lasting, can provide exercise and entertainment to the cat user while promoting clean and healthy teeth for the cat user, and is easy and inexpensive to manufacture. The present invention is directed to an improved cat chew toy.

### SUMMARY

Aspects of the invention provides a cat chew toy. The cat chew toy comprises an elongated stick extending longitudinally from a first end to an opposing second end, a first plurality of fibers extending outwardly from the first end of the stick, a second plurality of fibers extending outwardly from the second end of the stick, a dried fruit extending outwardly from one or both of the first and second ends of the stick, and a first rope winding around the elongated stick between the first and second ends thereof.

In some embodiments, a second rope, having first and second ends, is arranged to extend outwardly from the first end of the stick and/or the second end of the stick. In some embodiments, a loop portion is formed between the first and second ends of the second rope. In such embodiments, the dried fruit is strung on the second rope. The dried fruit may be slideable along the loop portion.

In some embodiments, the cat chew toy is made of materials comprising natural materials which are derived from a plant. In some embodiments, the cat chew toy is made of materials essentially comprising natural materials which are derived from a plant.

In some embodiments, the elongated stick and/or dried fruit is derived from the plant species Actinidia polygama. The elongated stick and/or dried fruit may be derived from a silver vine plant. In some embodiments, the elongated stick is derived from a stem of the plant. In some embodiments, the dried fruit comprises gall fruit.

In some embodiments, the first and/or second plurality of fibers and/or the first and/or second ropes comprise natural fibers. In some example embodiments, the first and/or second plurality of fibers comprise raffia fibers. In some example embodiments, the first and/or second ropes comprise sisal fibers.

Further aspects of the invention and features of specific embodiments of the invention are described below.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a front elevational view of a cat chew toy according to an example embodiment of the invention.

FIG. 2 is a close-up, front elevational view showing a first end of an elongated stick of the FIG. 1 cat chew toy.

FIG. 3 is a close-up, front elevational view showing a second end of the elongated stick of the FIG. 1 cat chew toy.

FIG. 4 is a perspective view showing four of the FIG. 1 cat chew toy.

FIG. 5 is a schematic diagram showing a cat with the FIG. 1 cat chew toy.

### DETAILED DESCRIPTION

An aspect of this invention relates to a toy for cats. The toy is designed for cats to chew on for entertainment and exercise, while simultaneously providing dental benefits to the cat user. In particular, the toy is preferably made with natural materials that are durable and/or indestructible.

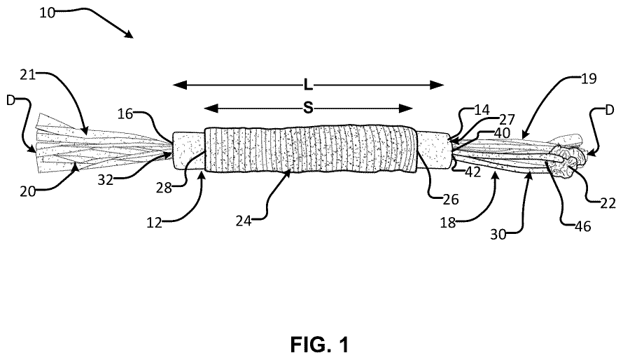

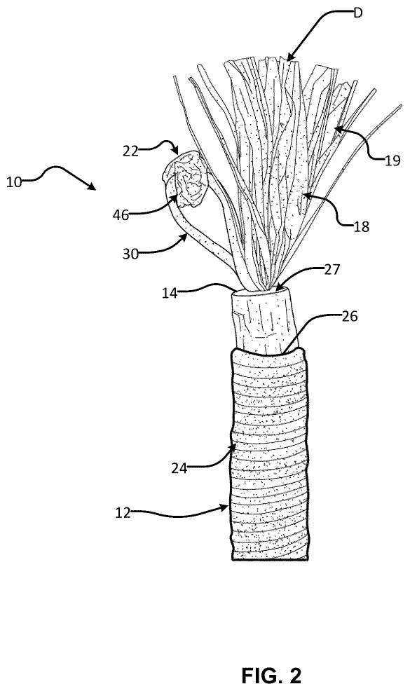

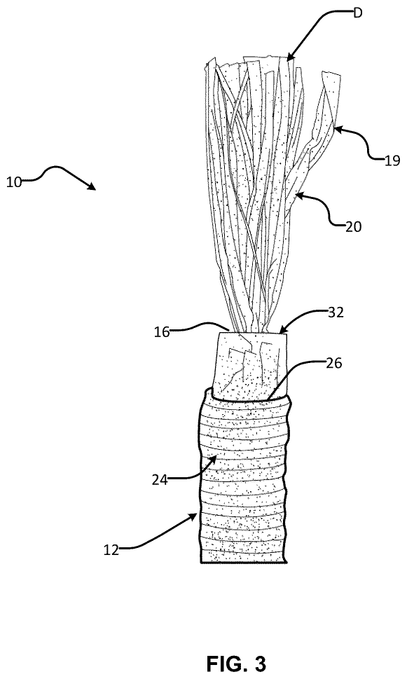

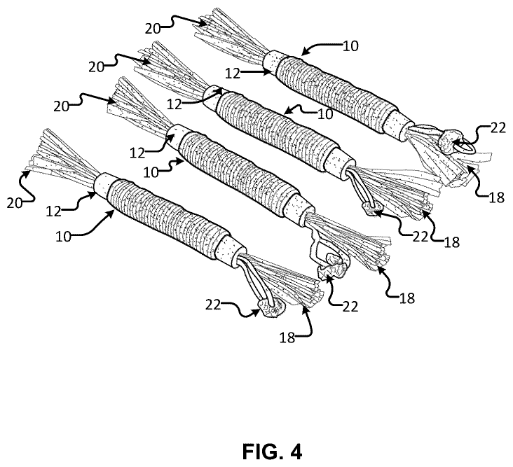

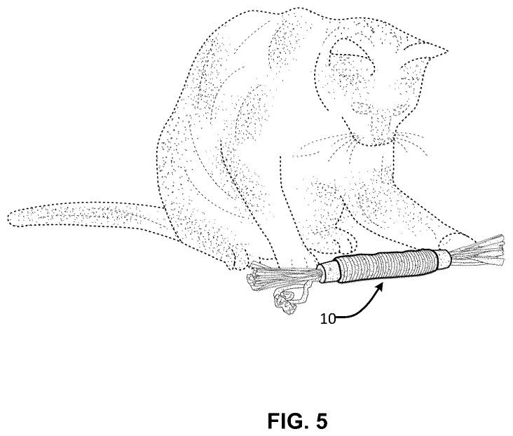

Referring to FIGS. 1 to 5, in one embodiment, the apparatus of the invention is a cat chew toy 10. The cat chew toy 10 comprises an elongated stick 12 having a first end 14 extending to an opposing second end 16. In some embodiments, a first plurality of fibers 18 are arranged to extend outwardly from the first end 14 of the stick 12. In some embodiments, a second plurality of fibers 20 are arranged to extend outwardly from the second end 16 of the stick 12. Each of the plurality of fibers which form the first or second plurality of fibers 18, 20 extend outwardly towards a distal end (D). The distal ends (D) of the plurality of fibers which form the first plurality of fibers 18 may each extend to an equal distance or substantially equal distances from the first end 14 of the stick 12. The distal ends (D) of the plurality of fibers which form the second plurality of fibers 20 may extend to an equal distance or substantially equal distances from the second end 16 of the stick 12.

A first rope 24 may be arranged to wind around the stick 12, along a segment(S) of the stick 12. The first rope 24 is secured on the stick 12. The segment(S) may extend a portion of an entire length (L) of the stick 12 between the first and second ends 14, 16 of the stick 12. In some embodiments, a midpoint of the segment(S) aligns with a midpoint of the stick 12. The midpoint of the segment(S) is the point along the segment(S) that is at the same distance or halfway between opposing ends 26, 28 of the segment(S). The midpoint of the stick 12 is the point along the stick 12 that is at the same distance or halfway between opposing ends 14, 16 of the stick 12. In some embodiments, the segment(S) extends more than half of the entire length (L) of the stick 12, and in some embodiments, the segment(S) extends more than about ¾ of the entire length (L) of the stick 12.

In some embodiments, a first channel 27 is defined within the stick 12. The first channel 27 may extend longitudinally from the first end 14 to a first point (not shown) within the stick 12. In such embodiments, a first portion (not shown) of a length of the first plurality of fibers 18 is snuggly fitted within the first channel 27, and a second portion 19 of the first plurality of fibers 18 extend outwardly from the first channel 27 and the first end 14 of the stick 12.

In some embodiments, a second channel 32 is defined within the stick 12. The second channel 32 may extend longitudinally from the second end 16 to a second point (not shown) within the stick 12. In such embodiments, a first portion (not shown) of a length of the second plurality of fibers 20 is snuggly fitted within the second channel 32, and a second portion 21 of the second plurality of fibers 20 extend outwardly from the second channel 32 and the second end 16 of the stick 12.

The first point that is positioned within the stick 12 may be more proximate to the first end 14 of the stick 12 than to the second end 16 of the stick 12. The second point that is positioned within the stick 12 may be more proximate to the second end 16 of the stick 12 than to the first end 14 of the stick 12.

In some embodiments, the first and second channels 27, 32 extend along a central axis of the elongated stick 12. In some embodiments, the first and second channels 27, 32 are in open communication with one another. In some embodiments, each one of the plurality of fibers which form the first and second plurality of fibers 18, 20 extends through both the channels 27, 32 to extend outwardly from each of the first and second ends 14, 16 of the stick 12.

A dried fruit 22 may be arranged to extend outwardly from one or both of the first and second ends 14, 16 of the stick 12. In some embodiments, the dried fruit 22 is arranged on a second rope 30. The second rope 30 may be arranged to extend outwardly from the first end 14 and/or the second end 16 of the stick 12. In some embodiments, the second rope 30 comprises a first end 40 extending to an opposing second end 42 thereof. The first and second ends 40, 42 of the second rope 30 may be snuggly fitted within the first channel 27 or the second channel 32 to extend from the same end 14, 16 of the stick 12. In some embodiments, the first end 40 of the second rope 30 extends outwardly to a loop portion 46, and therefrom extends to the second end 42 of the second rope 30. The dried fruit 22 may be strung on the second rope 30. In some embodiments, the dried fruit 22 is slideable along the loop portion 46.

In some embodiments, the distance from which the dried fruit 22 extends from the first and/or second ends 14, 16 of the stick 12 is less than the distance between the distal end (D) of the plurality of fibers 18, 20 and the first and/or second ends 14, 16 of the stick 12.

In some embodiments, the cat chew toy 10 is formed of materials comprising natural materials. In some embodiments, the cat chew toy 10 is formed of materials comprising essentially of natural materials. As used herein, a “natural material” means a material derived from plants, animals, insects or byproducts of plants, animals, and insects. In some embodiments, the cat chew toy 10 is formed of materials comprising or comprising essentially of natural materials that are derived from plants.

In some embodiments, the stick 14 and/or dried fruit 22 are derived from the plant species Actinidia polygama. The plant may be silver vine. In some embodiments, the stick 14 is derived from a stem of a silver vine plant. In some embodiments, the dried fruit 22 comprises a gall fruit.

In some embodiments, the first and/or second plurality of fibers 18, 20 comprise natural fibers. The natural fibers may be derived from plants. The natural fibers may for example be one or more of softwood fibers, hardwood fibers, elephant grass, nettle, buntal, buri, soybean protein, milvet milk, abaca, bagasse, bamboo, coir, cotton, flax, linen, hemp, jute, kapok, kenaf, pina, raffia, ramie, sisal, and combinations thereof. In some example embodiments, the first and/or second plurality of fibers 18, 20 comprise raffia fibers.

In some embodiments, the first and/or second ropes 24, 30 comprises natural fibers. The natural fibers may be derived from plants. The natural fibers may for example be one or more of softwood fibers, hardwood fibers, elephant grass, nettle, buntal, buri, soybean protein, milvet milk, abaca, bagasse, bamboo, coir, cotton, flax, linen, hemp, jute, kapok, kenaf, pina, raffia, ramie, sisal, and combinations thereof. In some example embodiments, the first and/or second ropes 24, 30 comprise sisal fibers.

Throughout the foregoing description and the drawings, in which corresponding and like parts are identified by the same reference characters, specific details have been set forth in order to provide a more thorough understanding to persons skilled in the art. However, well known elements may not have been shown or described in detail or at all to avoid unnecessarily obscuring the disclosure.

As will be apparent to those skilled in the art in the light of the foregoing disclosure, many alterations and modifications are possible in the practice of this invention without departing from the scope thereof. Accordingly, the description and drawings are to be regarded in an illustrative, rather than a restrictive, sense.

1. A cat chew toy comprising:
an elongated stick extending longitudinally from a first end to an opposing second end;
a first plurality of fibers extending outwardly from the first end of the stick;
a second plurality of fibers extending outwardly from the second end of the stick;
a dried fruit extending outwardly from one or both of the first and second ends of the stick, and
a first rope winding around the elongated stick.

2. The cat chew toy according to claim 1, wherein a first channel is defined within the stick extending from the first end of the stick to a first point in the stick, wherein the first point is positioned between the first and second ends of the stick.

3. The cat chew toy according to claim 2, wherein a second channel is defined within the stick extending from the second end of the stick to a second point in the stick, wherein the second point is positioned between the first and second ends of the stick.

4. The cat chew toy according to claim 2, wherein a first portion of a length of the first plurality of fibers are arranged within the first channel of the stick, and a second portion of the length of the first plurality of fibers are arranged to extend outwardly from the first end of the stick.

5. The cat chew toy according to claim 3, wherein a first portion of a length of the second plurality of fibers are arranged within the second channel of the stick, and a second portion of the length of the second plurality of fibers are arranged to extend outwardly from the second end of the stick.

6. The cat chew toy according to claim 1, wherein a channel is defined within the stick, the channel extending from the first end to the second end of the stick.

7. The cat chew toy according to claim 1, further comprising a second rope extending outwardly from one or both of the first and ends of the stick arranged to secure the dried fruit to the stick.

8. The cat chew toy according to claim 2, further comprising a second rope extending outwardly from the first channel.

9. The cat chew toy according to claim 8, wherein the second rope comprises a first end of the second rope disposed in the first channel, the first end of the second rope arranged to extend to a second opposing end of the second rope, and wherein the second end of the second rope is disposed in the first channel.

10. The cat chew toy according to claim 9, wherein a loop portion is formed between the first and second ends of the second rope.

11. The cat chew toy according to claim 10, wherein the dried fruit is moveable along the loop portion of the second rope.

12. The cat chew toy according to claim 1, wherein the stick and/or dried fruit is derived from a plant.

13. The cat chew toy according to claim 12, wherein the stick and/or dried fruit is derived from the plant species Actinidia polygama.

14. The cat chew toy according to claim 12, wherein the stick is derived from a stem of the plant.

15. The cat chew toy according to claim 12, wherein the dried fruit comprises gall fruit.

16. The cat chew toy according to claim 1, wherein the first and/or second plurality of fibers comprise natural fibers.

17. The cat chew toy according to claim 16, wherein the natural fibers comprise raffia fibers.

18. The cat chew toy according to claim 1, wherein the first rope comprises natural fibers.

19. The cat chew toy according to claim 1, wherein the first rope comprises sisal fibers.

20. The cat chew toy according to claim 8, wherein the second rope comprises sisal fibers.
